(19) United States
(12) Patent Application Publication
(10) Pub. No.: US 2001/0034935 A1
(43) Pub. Date: Nov. 1, 2001

(54) Tube finning machine

(76) Inventors: David Bland Pierce, Warwick (GB); Leigh Turley, Leamington Spa (GB)

Correspondence Address: INTELLECTUAL PROPERTY / TECHNOLOGY LAW, PO BOX 14329, RESEARCH TRIANGLE PARK, NC, 27709, US

(21) Appl. No.: 09/834,303

(22) Filed: Apr. 12, 2001

(30) Foreign Application Priority Data
Apr. 14, 2000 (GB) 0009184.3

(51) Int. Cl. B23P 15/26

(52) U.S. Cl. 29/726

(57) ABSTRACT

This invention relates to a tube finning machine, and in particular to improvements to such a machine. The invention relates to the field of heat exchangers, and in particular to the fitment of extended surface members (or fins) to the tubes of a heat exchanger so as to enhance the heat exchange. The tube finning machine has a rigid base, a clamping means for clamping a number of tubes, a carrier means movably mounted to the base, and a drive means by which the carrier means may be moved to a predetermined position relative to the base, and therefore relative to the tubes clamped thereupon. The improvements disclosed include those relating to support means for the tubes, clamping means for the tubes, and guide means for the fins as they are delivered to the carrier means.

### FIELD OF THE INVENTION

This invention relates to a tube finning machine, and in particular to improvements to a machine such as that disclosed in patent application WO96/35093.

Such a tube finning machine has a rigid base, a clamping means for clamping a number of tubes, a carrier means movably mounted to the base, and a drive means by which the carrier means may be moved to a predetermined position relative to the base, and therefore relative to the tubes clamped thereto. In WO96/35093 the drive means is a linear motor, but it will be understood that the present improvements may be used with tube finning machines having other suitable drive means.

### BACKGROUND TO THE INVENTION

WO96/35093, and the present improvements, relate to the field of heat exchangers, and in particular to the fitment of extended surface members (or fins) to the tubes of a heat exchanger so as to enhance the heat exchange. It is known to fit individual fins to the or each tube of a heat exchanger, and it is also known to fit a common-fin comprising a single component which can engage at least two tubes. The tube finning machine of WO96/35093, and most of the present improvements, can be used in both of these arrangements.

The first improvement relates to the support of the tubes as the fins are placed thereon, and also as the fins are moved therealong. Notwithstanding that various designs of support means are disclosed in WO96/35093, modified support means have been developed which are particularly advantageous with larger tube finning machines.

In addition, the improved support means can support the tube or tubes whilst the fin is being passed therealong, without requiring the tube or tubes to engage the moving carrier means; since such engagement would induce friction (and therefore heat) into the tubes and carrier, avoiding or reducing the sliding contact between the carrier means and the tubes is particularly advantageous.

The second improvement relates to a modified method of clamping the tubes to the machine.

The third improvement relates to a guide means for the delivery of fins to the carrier means.

The fourth improvement also relates to the delivery of fins to the machine, in particular fins with pre-formed collars, and overcomes the propensity of such fins to “nest” together following manufacture and during transportation to the machine, in which the collars of adjacent fins become engaged and can become bound together, preventing a single fin being delivered to the carrier means.

### SUMMARY OF THE INVENTION

The first improvement has resulted in a tube finning machine having a rigid base, a clamping means adapted to clamp a number of tubes in triangular array, a carrier means movably mounted to the base and adapted to carry at least one fin, drive means for the carrier means, and support means by which at least some of said tubes may be supported when clamped to the machine, the support means being movable relative to the base and having at least two rows of arcuate support surfaces.

It will be understood that by “triangular array” is meant that the tubes are arranged in at least two rows, with the tubes in each row being offset from the tubes in the adjacent rows. Such an array (with two rows of tubes) is shown in FIG. 5 for example. The provision of the tubes in triangular array enables a part of the support means to pass between adjacent tubes in one row and engage a tube in another row; the provision of arcuate support surfaces enables the support means to provide lateral support to tubes in both rows. In addition, in embodiments in which the longitudinal axis of fitted tubes is substantially horizontal (as opposed to substantially vertical), the support surfaces can provide vertical as well as lateral support.

Preferably, the support means is attached to the carrier means, and is pivotable about a substantially horizontal axis. When the carrier means clears the end(s) of the tube(s) (so that the tubes are otherwise only supported in cantilever), the support means is pivoted into supporting engagement with the tubes so as to support the free ends thereof. As the carrier means passes the end of the tube(s) with the next fin, the support means is moved out of engagement with the tubes, so that the free ends of the tubes are supported only by the carrier means.

Preferably also, additional support means are provided “behind” the carrier means, which additional support means is advanced over the ends of the tubes when the carrier means has passed sufficiently far along the tubes. The additional support means provides support for the free ends of the tubes, and avoids or reduces the support provided to the tubes by the carrier means. This reduces or avoids the sliding engagement between the carrier means and the tubes as the carrier means passes along the tubes, so reducing the friction therebetween.

Further support means may be provided along the length of the tubes. Thus, lateral support of the tubes at specific positions along their length may be desired in applications utilising long and/or small tubes, which might otherwise tend to deform under the load induced by the fitment of fins. Two such further support means may be provided, arranged to face in opposed directions; if there are two rows of clamped tubes the further support means may provide “total” support for all of the tubes, i.e. all of the tubes may be supported against vertical and lateral movement substantially along their complete lengths.

The second improvement has resulted in a tube finning machine having a rigid base, a clamping means adapted to clamp at least one tube, a carrier means movably mounted to the base and adapted to carry at least one fin, and drive means for the carrier means, the clamping means including a resiliently deformable sleeve member and a drive member, the drive member being movable to compress the sleeve member axially and cause the sleeve member to expand laterally.

It is a particular advantage of the improved clamping means that the clamping is effected “internally” of the tubes and not “externally”. This allows fins to be positioned right up to the clamped end of the tubes if desired. It will be understood that the improved clamping means can be used with one tube only, with a single row of tubes, or with a triangular or other array of tubes, as desired.

The third improvement has resulted in a tube finning machine having a rigid base, a clamping means adapted to clamp at least one tube, a carrier means movably mounted to the base and adapted to carry at least one fin, drive means for the carrier means, delivery means adapted to deliver successive fins to the carrier means, and movable guide means mounted adjacent the delivery means, the movable guide means having a tapered guide surface adapted to guide a fin into position adjacent to the carrier means. It will be understood that the guide means can be used upon a machine being used to fin a single tube, a single row of tubes, or with a triangular or other array of tubes, as desired; if a row or array of tubes is being finned, the guide means is suited to use with a common-fin rather than separate fins for each of the tubes.

The fourth improvement has resulted in a delivery means including an angled slide onto which the fins are loaded, so as to move along the slide under the influence of gravity. A pick-up means can be arranged adjacent the slide, which can engage a single fin and can move it away from the slide and place it adjacent the carrier means. Adjacent the location of the pick-up means the path of the fins is arranged to be arcuate, passage of the fins around the arc causing the fins to “fan out”, breaking down any binding interaction between adjacent fins. Following passage of the fins around the arc, the collars of each fin are not bound to the collars of the adjacent fin, and each fin can subsequently be removed from the stack by the pick-up means, without hindrance from the successive fins,

Preferably, the angle of the slide can be adjusted. In this way, the optimum angle can be set for each type of fin, it being recognised that a greater angle relative to the horizontal will result in more definite passage of the fins towards the pick-up means (under the influence of gravity), but will also result in a greater likelihood that adjacent collars will become bound together.

The provision of the arcuate path for the fins in the delivery means avoids the requirement for special provisions to be undertaken to avoid adjacent fins becoming bound together, i.e. the fins are not required to be kept apart following manufacture or subsequent transportation, but can be packed closely together. Even if adjacent fins become bound together following manufacture and/or during transportation to the tube finning machine, they can subsequently be separated by the delivery means.

A further improvement is directed to machines utilising a linear motor and having a set of permanent magnets mounted to the base. The improvement relates to a covering means provided between the magnets and the carrier means and tubes, which covering means protects the magnets from dirt and debris, and also prevents fins or other materials which might be dropped adjacent the machine from falling onto the magnets, so reducing the likelihood of damage to the magnets.

### BRIEF DESCRIPTION OF THE DRAWINGS

The invention will now be described, by way of example, with reference to the accompanying schematic drawings, in which:

FIG. 1 shows a representation of a tube finning machine such as that disclosed in WO96/35093;

FIG. 2 shows a side view of a part of the delivery means according to the present improvements, with several fins loaded thereon;

FIG. 3 shows a side view of a part of a tube finning machine having support means and additional support means according to the present improvements;

FIG. 4 shows a side view as in FIG. 3, but at a later stage in the tube finning process;

FIG. 5 shows an end view of part of the finning machine of FIG. 3, fitted with a covering means;

FIG. 6 shows an end view of part of the support means;

FIG. 7 shows a side view of an alternative embodiment of tube finning machine, fitted with further support means;

FIG. 8 shows a perspective view of a clamping means according to the present improvements;

FIG. 9 shows a sectional side view of the clamping means of FIG. 8;

FIG. 10 shows a sectional side view of part of the clamping means of FIG. 8, with a tube clamped thereby;

FIG. 11 shows a view of part of a carrier means and a guide member according to the present improvements;

FIG. 12 is a sectional view at the line XII-XII of FIG. 11; and

FIG. 13 is a sectional vies at the line XIII-XIII of FIG. 11.

### DESCRIPTION OF THE PREFERRED EMBODIMENTS

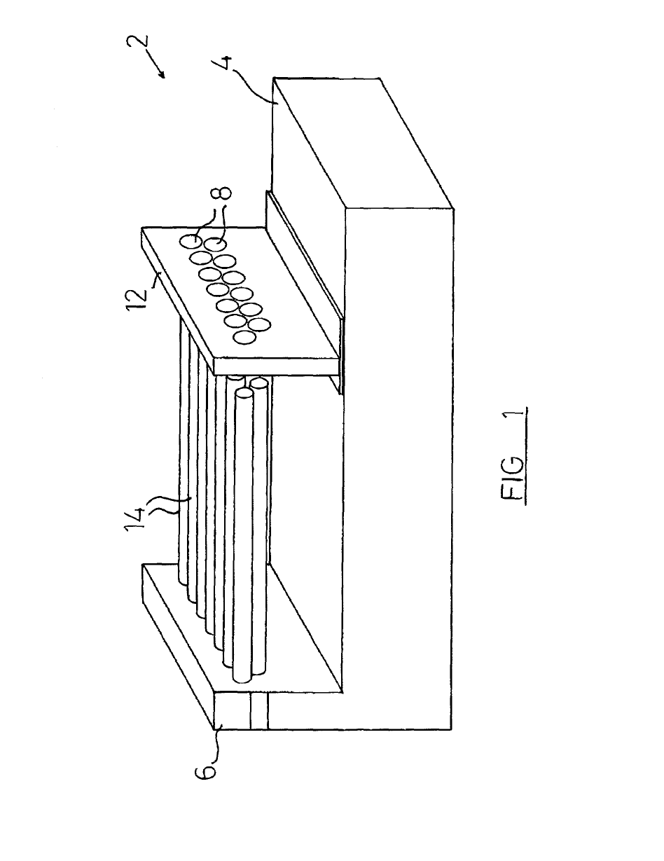

A tube finning machine 2 is shown schematically in FIG. 1. That machine has a rigid base 4 to which is mounted a clamping means 6. In this embodiment, the clamping means is adapted to clamp one end of each of thirteen tubes 14, arranged in two rows in triangular array, one of the rows containing seven tubes the other row containing six tubes. A carrier means 12 is movably mounted to the base, suitably by guide bars (not shown) along which it can slide. In addition, one or both of the carrier means 12 and the base 4, carry drive means (also not shown) by which the carrier means 12 may be moved to a predetermined position relative to the base, and therefore relative to the tubes 14.

The carrier means 12 has a number of apertures 8, the apertures 8 being slightly larger than the tubes and being positioned to correspond to the tubes 14. It will be understood that as the carrier means 12 moves along the base 4, each of the apertures 8 passes around and along a respective tube 14.

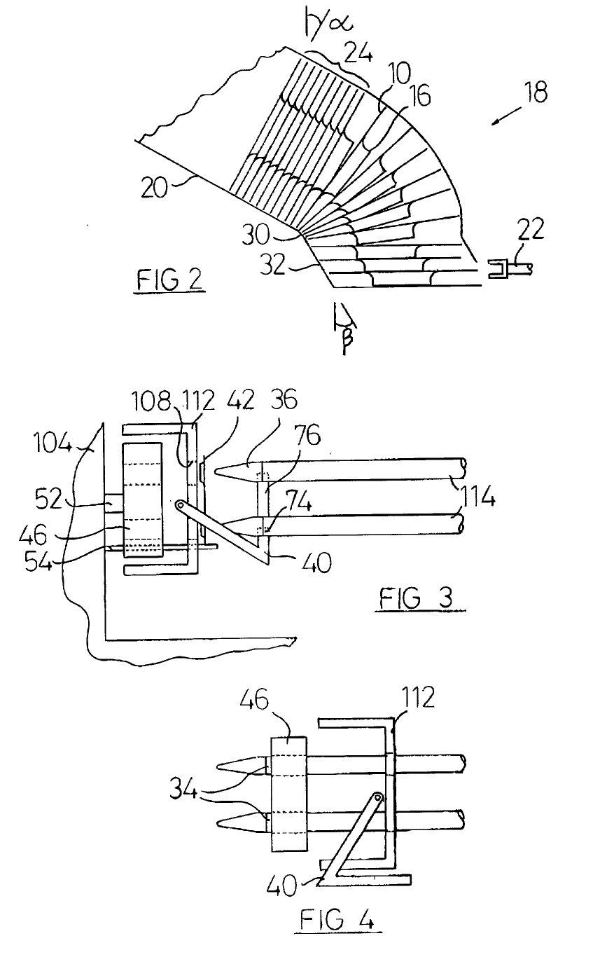

The carrier means 12 is designed to transport one or more common-fins (a common-fin is a single component which can engage more than one tube 14) or a set of single fins (each single fin being adapted to engage a single tube 14) along the tube, and to position those fin(s) at a predetermined position upon the tube(s). The fins are pre-apertured, i.e. having a number of apertures or openings therein corresponding to the size and arrangement of the tubes which are intended to be finned. To increase the heat exchange between the tubes and the fins, in most applications the fins have a collar (such as the collar 16 of the fin of FIG. 2) surrounding each aperture, the collar typically being formed as the aperture is pressed out of the fin.

The fin or fins are not shown in FIG. 1, but a fin 10 having a single row of openings, and hence being suitable for fitment to a single row of tubes 14, is shown in FIG. 2.

Whilst it is possible to deliver the fins 10 individually to the carrier means 12, perhaps by hand, it is desirable to have this process automated, and in such cases a large number of fins 10 can be placed into a carriage or other delivery apparatus (not shown in FIG. 1), with pick-up means being provided to extract one fin at a time from the delivery apparatus and place it adjacent the carrier means 12.

The important elements of one such delivery apparatus 18 is shown in FIG. 2, which comprises an angled slide 20 and a pneumatically controlled pick-up 22. In known fashion, the pick-up 22 can clamp onto one fin 10, withdraw it from the stack of fins, and place it adjacent the carrier means 12 (not shown in FIG. 1). However, as will be seen from the body of fins 24, the collars 16 of each fin have become engaged with the collars of the adjacent fins. This engagement will typically occur during transportation from the site of manufacture of the fins to the tube finning machine, but could also occur on the delivery apparatus itself. Since all of the fins are necessarily substantially identical, the chances of adjacent fins becoming bound together is considerable, which binding together will make it difficult or even impossible for the pick-up means 22 to extract a single fin 10 from the delivery means 18.

To break up the binding between adjacent fins, the delivery apparatus includes an arcuate or curved section 30. The presence of the curved section 30, and the influence of gravity upon the fins, causes the fins to fan-out as they pass around the arc, releasing the collar of each fin from the collars of its neighbours.

As the fins are passed around the curve 30, they move from an angle α to the vertical to a substantially horizonal orientation, in which orientation they can be extracted by the pick-up means 22.

To ensure that the collars 16 do not again become bound after the fins have passed around the curve 30, the curve 30 is arranged to be very close to the pick-up 22. Also, the wall 32 of the delivery apparatus is arranged to be at an angle β beyond the curve, which angle β has been set to be sufficiently great to prevent the collar of one fin from engaging the aperture of an adjacent fin, i.e. following their passage around the curve 30 the collars of adjacent fins are no longer co-axial, and the collar of each fin rests upon the planar surface of the adjacent fin and so cannot become bound thereto.

In the schematic representation shown the walls of the delivery apparatus are fixed, and so the angles α and β are fixed. However, in more complex arrangements it can be arranged that the angle α can be adjusted, and perhaps also the angle β. Adjustment of the angle α might be required depending upon the size and weight of the fins, it being recognised that heavier fins are more prone to becoming bound together, and reducing the angle α will reduce the tendency for the fins to bind together upon the delivery apparatus. In addition, the number and size of the apertures, and the form of the collars, of the fins will affect the tendency of adjacent fins to become bound together. In any event, however, it is desired that the fins move down the slide 20 under the influence of gravity, rather than any other force having to be imparted to them.

It will be understood by those skilled in the art that movements of the delivery apparatus which will occur as the machine undergoes its finning cycles will assist in ensuring that the fins 10 move down the slide 20, and also that they become separated as they pass around the curve 30.

FIGS. 3 and 4 show the support means and additional support means which provide support to the free ends 34 of the tubes 114. It will be understood that the tubes 114 might be of considerable length (perhaps up to 6 metres), and so might tend to sag adjacent their free ends. The degree of sagging would increase as the fins are added thereto, i.e. as the weight of the tubes and the attached fins increases.

To facilitate passage of the carrier means 112 over the ends 34 of the tubes 14, the ends of the tubes are each fitted with a centralising cone (or bullet) 36. It will be understood that the bullet 36 is only present whilst the tubes are being finned; after completion of finning the bullets 36 are removed. The bullets 36 also ease the passage of the fins 10 onto the tubes 14, it being usual for there to be a tight grip between the collars 16 of the fins and the tubes so as to enhance the thermal contact therebetween; it may therefore be necessary to expand the collar 16 slightly as the fin is pushed onto the tubes, and the taper of the bullets enables this to be achieved progressively rather than suddenly as would be the case if the collar encountered the flat end of the tubes 14.

As can be seen in FIG. 3, located upon the carrier means 112 is a support 40, which is mounted to pivot relative to the carrier means between an operative position (FIG. 3) and an inoperative position (FIG. 4) The support 40 is movable between its operative and inoperative positions by way of a pneumatic ram (not shown) mounted upon the carrier means, though in other embodiments electrical actuation or other form of mechanical actuation could be utilised if desired.

It is arranged that the support 40 moves to its operative position each time the carrier means 112 approaches the end of its travel, and becomes free of the tubes 114. In such circumstances the free ends of the tubes are not supported by the carrier means, and might otherwise sag. The support 40 therefore supports the tubes 114 whilst the next fin (42 in this embodiment) is being loaded adjacent the carrier means. The support 40 remains in place until the carrier means 112 starts its next cycle, and in particular until the carrier means has passed the free ends 34 of the tubes. Thereafter, the support means 40 assumes its inoperative position as shown in FIG. 4, the free ends 34 of the tubes 114 being supported by the carrier means 112, and specifically by the apertures 108 in the carrier means 112.

Whilst it would be possible to utilise only the support 40 together with the carrier means 112 to support the tubes 114 during the tube finning operation, in practice this will result in sliding engagement between the carrier means (and in particular between the lower portions of the walls surrounding the apertures 108) and the tubes 14. This sliding engagement will result in frictional losses, and the build-up of heat in the carrier means and the tubes. To avoid or reduce this, an additional support 46 is provided.

The additional support 46 is carried by the machine base 104, and is mounted thereon by a ram 52. In this embodiment the ram is a pneumatically-actuated piston, but in other embodiments could be a mechanical toggle mechanism, a screw drive, or other suitable drive means.

When the carrier means 112 is in its rest position as shown in FIG. 3 the additional support 46 is also in its rest or inoperative position. However, when the carrier means 112 moves beyond the free end 34 of the tubes 14, as shown in FIG. 4, the additional support 46 is advanced. The additional support 46 has an array of apertures corresponding to the size and positions of the tubes 14, and is moved over the free ends of the tubes to provide support for the tubes, and in particular to reduce or avoid the support which would otherwise be provided by the carrier means 12. With the additional support 46 positioned as shown in FIG. 4, the carrier means 112 can be moved along the tubes with little or no sliding engagement, and therefore little or no friction, with the tubes 14.

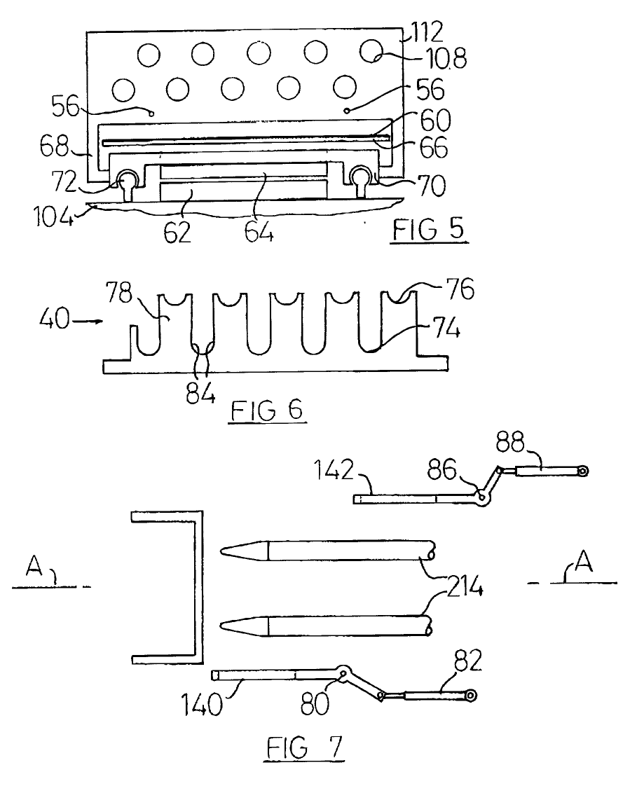

FIG. 3 also shows a bar 54 which is used to position the fins 42 as they are placed adjacent the carrier means. In fact, there are two bars 54, one to each side of the fin 42, though only one can be seen in this side view. The (immovable) support bars 54 are mounted upon the machine base 104, and pass through respective apertures 56 in the carrier means 112 (see FIG. 5), and corresponding apertures in the additional support 46.

When the machine is in operation, a fin 42 is placed on the bars 54 between the free ends of the tubes and the carrier means 112. Since the gap between the free ends of the tubes 114 and the carrier means 112 will in an event be small, the absence of any separate lateral support for the fin is not significant, since the fin will lie against one or other of the tubes 114 and the carrier means 112. As soon as the carrier means 112 begins to move, the fin 42 will be pushed onto the tubes 112, with the bullets 34, the apertures 108 in the carrier means 112, and the collars of the fins which are engaged thereby, acting to position the fins relative to the tubes.

Though not shown in the drawings, an optical transmitter/receiver is provided upon the base 104 which can project a beam of light through aligned apertures in the additional support 46 and the carrier means 112, which beam of light is reflected by the surface of a fin when a fin is present between the carrier means and the free end of the tubes, the presence of a fin being communicated to the control unit of the machine and enabling the machine to initiate movement of the carrier means. In this way, the carrier means will only start its cycle along the tubes when a fin is present.

FIG. 5 shows the carrier means 112, and also demonstrates the arrangement of the apertures 108 therein, which apertures correspond to the positions of the tubes 114 in this embodiment. In this embodiment there are ten tubes, arranged in two rows, the tubes in each row being offset to provide the triangular array desirable in many heat exchanger applications.

FIG. 5 also shows the covering means 60 which is arranged to lie between the carrier means 112 and the drive means, the drive means in this embodiment being a linear motor comprising a permanent magnet 62 and electrical windings 64. Thus, whilst it is possible to provide a linear motor drive in which two sets of electrical windings interact, in the embodiment shown one of the windings is replaced by a permanent magnet (or a set of permanent magnets) which run substantially the full length of the machine base 104.

In order to prevent dirt and debris falling onto the permanent magnet the covering means 60, which comprises a thin sheet of metal or plastic, covers the full width and length of the magnet 62. The covering means is mounted upon a frame 66 which is itself supported at each end of the base 104, i.e. the frame 66 and covering means 60 are suspended between fixed positions adjacent the longitudinal ends of the base 104.

In this embodiment the carrier means 112 has a pair of legs 68 which are connected to the bearing mounts 70, which bearing mounts also support the structure upon which the windings 64 are mounted. The bearing mounts 70 are located by way of bearings upon runners 72, which runners lie along substantially the full length of the base 104. In this way, propelled by the interaction between the magnet 62 and windings 64, the bearing mounts can slide along the respective runners 72, carrying the carrier means 112 therewith. As the carrier means is moved along the base 104, it passes above the covering means 60, whilst the windings 64 and their support structure, pass underneath the covering means.

FIG. 6 shows the desired form of the support 40 for use with a two-row triangular array of tubes such as that of FIGS. 3-5. The support 40 has two sets of part-circular formations, set 74 for supporting the lower row of tubes, and set 76 for supporting the upper row of tubes. It will be seen that the triangular array of the tubes 114 enables the pillars 78 carrying the formations 76 to pass between adjacent tubes in the lower row.

It will be noted that in the embodiment of FIG. 2, the fins 10 each have only one row of collars, and if the machine is set up to fin a set of tubes in a single row the support need only have a series of formations in a single row, and for example the pillars could terminate at (or preferably slightly above) the curved portion of the formations 74.

FIG. 7 shows part of an alternative tube finning machine, and the (further) support means thereof. In this embodiment, the support means 140 is mounted to the base of the machine rather than to the carrier means, and is adapted to pivot about an axis 80 under the influence of a pneumatic actuator 82. It will be seen that there are two rows of tubes 214, and if the tubes are arranged in triangular array as is usually preferred the support 140 may be similar to that of FIG. 6.

It will be apparent that when using a support such as that of FIG. 6 the lower row of tubes is supported laterally, specifically by the walls 84 of the formations 74. However, less lateral support is provided to the upper row of tubes. It is sometimes necessary to provide lateral support along the length of the tubes for all of the tubes, since otherwise (and particularly with longer and/or smaller diameter tubes), the tubes may diverge laterally to an unacceptable extent, e.g. perhaps preventing the carrier means from being able to pass the free end thereof. To provide additional lateral support for the upper row of tubes, the embodiment of FIG. 7 includes a secondary support 142 which is pivotable about axis 86, and is independently actuated by a pneumatic actuator 88. The form of the support 142 is identical to that of support 140 (but inverted), so that the additional lateral support provided to the lower tubes by the support 140 is provided to the upper tubes by the support 142. When both of the supports 140 and 142 are in their operative positions, all of the tubes are substantially prevented from moving upwardly, downwardly, or laterally.

It is not necessary that the support means 140, 142 lie close together along the longitudinal axis A-A of the tubes, and some spacing between the respective support means is desired to ensure that the support means do not contact each other during pivoting movement thereof. Clearly, several support means 140, 142 can be arranged at chosen positions along the longitudinal axis A-A, to suit the length and flexibility of the tubes.

It is of course possible to utilise a combination of the (further) supports 140 and/or 142, a support 40 (FIGS. 3, 4) and an additional support 46 (FIGS. 3, 4), as desired.

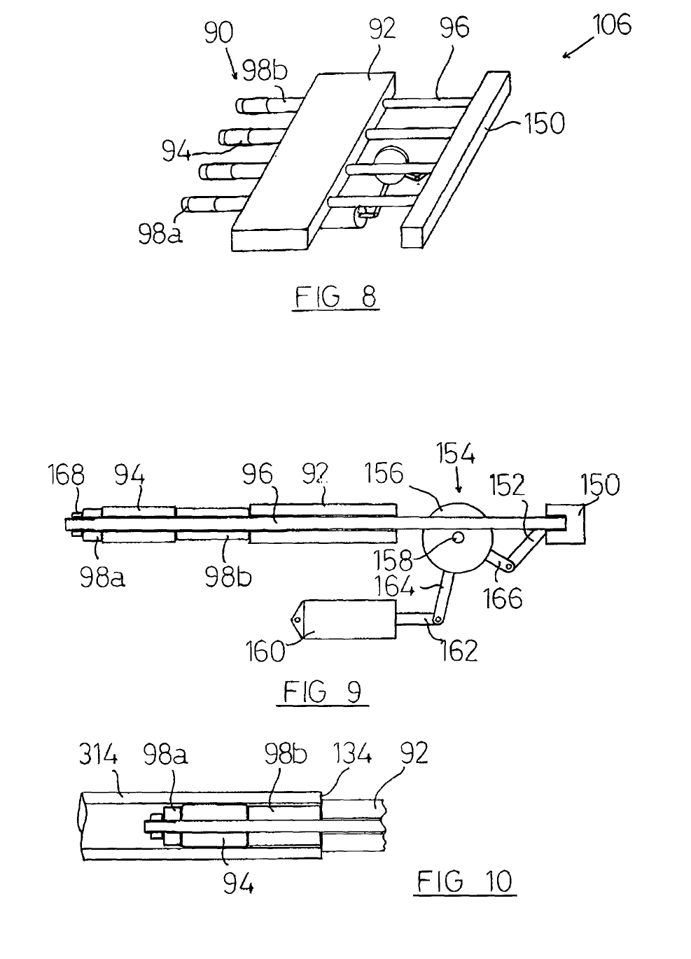

FIGS. 8-10 show an alternative means 106 for clamping the tubes. In this embodiment, a set of clamping members 90 are carried by a support 92 which is secured to the machine base (not shown in FIG. 8). The clamping members comprise a resilient sleeve 94 which surrounds a drive rod 96, the drive rod also being surrounded by respective collars 98a, 98b which lie to either side of the resilient sleeve 94. The drive rod 96 of each clamping member passes through an opening in the support 92, and is connected to a rail 150. The rail is engaged by a link 152 of a cam mechanism 154, which cam mechanism includes a pivotable wheel member 156 which can be rotated about its fixed pivot 158 by way of a pneumatic ram 160. It will be understood that when the pneumatic ram is actuated, its piston 162 is caused to extend. This drives a link 164 which is fixed to the wheel 156, which in turn drives the link 166 and consequently the link 152, causing the rail 150 to move to the right as drawn.

Rightwards movement of the rail 150 causes corresponding rightwards movement of the drive rod(s) 96. The drive rods 96 are arranged to be substantially inextensible, and the collars 98a, 98b and the support 92 are arranged to be substantially incompressible. Accordingly, by virtue of the nut 168 which is secured to the threaded end of the drive rod 96, rightwards movement of the drive rod will compress the resilient sleeve 94 between the collars 98a, b. Axial compression of the resilient sleeve 94 will result in lateral expansion thereof, and with suitable componetry it can be arranged that the resilient sleeve is forced into clamping engagement with the inside surface of a tube 314 (as show in FIG. 10).

It is a particular advantage of the clamping means of FIGS. 8-10 that the tube finning machine presents no impediment to finning of the tubes right up to the clamped end 134 of the tubes. Thus, if it is desired to fit fins up to (or very close to) the clamped end 134 of the tubes, this can be achieved with such a clamping means. In addition, the clamping means is very quick and easy to operate, and all of the tubes can be clamped by actuation of a single pneumatic ram. The clamping means is not limited to a particular number or arrangement of tubes, i.e. the rail 150 can be extended to carry more than four drive rods 96 in a single row, for example, and also to carry drive rods in two or more rows, as desired for the particular application.

It can be arranged that the pneumatic ram is dual-acting, and can be actuated to withdraw the piston 162 to forcibly unclamp the tubes. Alternatively, a spring or other resilient biassing means may be employed to effect leftwards movement of the drive rods 96 and relaxation of the resilient sleeves 94.

The provision of a nut 168 in threaded engagement with the drive rod allows the axial compression of each resilient sleeve 94 to be adjusted, so that the axial compression (and therefore the lateral expansion) of each resilient sleeve can be matched to the other sleeves. The size of the resilient sleeve, and the frictional force which can be provided by the lateral expansion obtained, can be varied to suit the application, longer and heavier tubes requiring a greater frictional (clamping) force between the expanded sleeve and the inside of the tube.

A suitable material for the resilient sleeve has been found to be urethane, but other materials are also believed likely to be suitable.

Whilst in this embodiment one particular means to move the rail 150 is disclosed, it will be apparent that many other suitable means could be used instead. The other suitable means could include hydraulic or electrical actuation by way of suitable linkages. Alternatively, the hydraulic, electrical or pneumatic actuator could act directly upon the rail 150, though it is preferred that linkages be used since these provide the possibility of an “over-centre” position to be attained in which the drive rods are effectively locked whilst tube finning is underway.

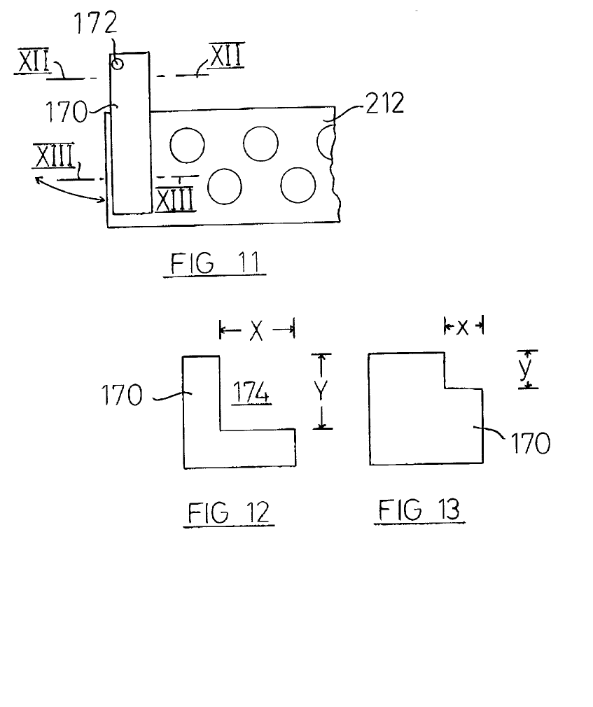

FIGS. 11-13 show a guide member 170 for guiding a fin into position adjacent the carrier means 212. Thus, whilst as above indicated it is possible to place each individual fin adjacent the carrier means, it has been found more practical to allow each fin to drop into position adjacent the carrier means under the influence of gravity. Guide means are required to ensure that the fins will reliably drop into the correct position.

In the embodiment shown in FIG. 11, the tubes are arranged in two rows in triangular array (and the carrier means 212 is correspondingly configured), and it is intended that a set of common-fins will be fitted, each common-fin engaging all of the tubes in the array. The guide member 170 is located to one side of the carrier means, and another similar guide member (but oppositely configured and arranged) is located to the other side of the carrier means; the guide members together locate the opposed ends of the common-fin, and thereby serve to position the whole of the fin adjacent the carrier means. The guide members lie immediately to the right of the carrier means in the orientation of FIG. 3, and immediately in front of the carrier means in the orientation of FIG. 11.

The guide member 170 is mounted upon a pivot 172, and can be pivoted thereabout by suitable means (not shown). Thus, a pneumatic, electrical or mechanical actuator can be provided to pivot the guide member 170.

As seen in FIGS. 12 and 13, the guide member 170 has a guide recess 174 formed therein (the recess facing the carrier means 212). The guide recess tapers along the length of the guide member, and reduces in size towards the bottom of the guide member (as drawn in FIG. 11). Thus, when the leading edge of the end of a fin enters the guide member from above, it initially has a relatively large degree of freedom therewithin (i.e. the end of the fin can move within an area similar to that defined by the dimensions X and Y in FIG. 12), allowing the fin to move by a relatively large distance away from the carrier means, and also by a relatively large distance leftwards and rightwards in the orientation of FIG. 11). The provision of a relatively large guide recess at the top of the guide member 170 ensures that the accurate positioning of the fin as its drops thereinto is not critical.

As the fin moves downwardly its ends become increasingly restricted by the guide member(s) 170, until they can only move within an area similar to that defined by x and y in FIG. 13. This restriction in the possible movement of the ends of the fin allows the fin effectively to be guided into a position adjacent the carrier means 212 in which it can reliably be moved onto the tubes. The absence of any steps within the guide member, and thus within the path of the end of the fin, help to ensure that the fin does not foul the guide member, which fouling could prevent proper location of the fin adjacent the carrier means.

In alternative but less preferred embodiments, the guide recess can taper in only one direction, i.e. either the dimension X or the dimension Y is fixed throughout the length of the guide member.

In this embodiment the guide members are carried by the base of the machine, and so must be moved out of the path of the carrier means before the carrier means can be moved. Alternatively, however, the guide members can be carried by the carrier means, and can remain in position until the fin has been moved over the ends of the tubes.

In addition to the restriction provided by the tapering recess of the guide member, it can be arranged that the guide member is angled inwardly, i.e. the guide member 170 can if desired be pivoted to a position slightly beyond that shown in FIG. 11, so as to further restrict the fin as it moves down the guide member.

The guide member 170 is intended to be used with a tube finning machine having a bar (such as the bar 54 of FIG. 3) or other means to limit the downward movement of the fin. Alternatively of course, in embodiments in which the guide members are carried by the carrier means the guide members can include a shoulder or other stop adjacent its lower edge.

It will be apparent that many improvements have been disclosed herein, some of which can be used together if desired. However, it is possible that each of the separate improvements could be used on a tube finning machine independently of the other improvements.

1. A tube finning machine having a rigid base, a clamping means adapted to clamp a number of tubes in triangular array, a carrier means movably mounted to the base and adapted to carry at least one fin, drive means for the carrier means, and support means by which at least some of said tubes may be supported when clamped to the machine, the support means being movable relative to the base and having at least two rows of arcuate support surfaces.

2. A tube finning machine according to claim 1 in which the longitudinal axis of the tubes when clamped to the machine is substantially horizontal, and the support surfaces also provide vertical support to some of the tubes.

3. A tube finning machine according to claim 1 having two support means, each support means being movable relative to the base and having at least two rows or arcuate support surfaces.

4. A tube finning machine according to claim 3 in which the clamping means is adapted to clamp a number of tubes in triangular array in only two rows, and in which the support means provide lateral and vertical support for all of the tubes.

5. A tube finning machine according to claim 3 in which the support means are spaced apart along the longitudinal axis of the base.

6. A tube finning machine according to claim 1 in which the support means is mounted upon the carrier means and is movable relative to the carrier means.

7. A tube finning machine according to claim 1 in which an additional support means is located behind the carrier means.

8. A tube finning machine according to claim 1 having delivery means adapted to deliver successive fins to the carrier means, and movable guide means mounted adjacent the delivery means.

9. A tube finning machine according to claim 8 in which the movable guide means has a tapered guide surface adapted to guide a fin into position adjacent to the carrier means.

10. A tube finning machine according to claim 8 in which the guide means is pivotably mounted to the machine.

11. A tube finning machine according to claim 8 in which the guide means is pivotably mounted to the carrier means.

12. A tube finning machine according to claim 1 in which the clamping means is adapted to engage the interior of the tubes.

13. A tube finning machine according to claim 12 in which the clamping means includes a resiliently deformable sleeve member and a drive member, the drive member being movable to compress the sleeve member axially and cause the sleeve member to expand laterally.

14. A tube finning machine according to claim 12 in which the resiliently deformable sleeve is mounted upon the drive member and is located between two collars which are also mounted upon the drive member.
